(19) United States
(12) Patent Application Publication
(10) Pub. No.: US 2016/0047652 A1
(43) Pub. Date: Feb. 18, 2016

(54) ANGULAR VELOCITY SENSOR

(71) Applicant: Asahi Kasei Kabushiki Kaisha, Tokyo (JP)

(72) Inventors: Koji MATSUSHITA, Tokyo (JP); Masaya YAMASHITA, Tokyo (JP)

(73) Assignee: ASAHI KASEI KABUSHIKI KAISHA, Tokyo (JP)

(21) Appl. No.: 14/923,638

(22) Filed: Oct. 27, 2015

Related U.S. Application Data
(63) Continuation of application No. PCT/JP2014/002199, filed on Apr. 17, 2014.

(30) Foreign Application Priority Data
Apr. 30, 2013 (JP) 2013-095660

(51) Int. Cl. G01C 19/56

(52) U.S. Cl. CPC G01C 19/56

(57) ABSTRACT

An angular velocity sensor is provided, the angular velocity sensor comprising: a housing an outer edge shape of which is a polygon in a planar view; a planar substrate fixed to the housing; a vibrating weight that is surrounded by the housing and is formed to extend in a perpendicular direction in relation to the planar substrate on the planar substrate; and a vibrating unit to vibrate the vibrating weight in a predetermined direction, wherein the vibrating unit vibrates the vibrating weight in a different direction from a direction of a straight line that connects the shortest distance between the outer edge of the housing and the center of gravity of the vibrating weight in a planar view.

The contents of the following Japanese patent application(s) are incorporated herein by reference:
2013-095660 filed in JP on Apr. 30, 2013.

### BACKGROUND

1. Technical Field

The present invention relates to an angular velocity sensor. In particular, the present invention relates to an angular velocity sensor that detects Coriolis force by vibrating a vibrating weight.

2. Related Art

FIG. 1 is a figure illustrating one example of a conventional angular velocity sensor 500. FIG. 1 shows a top view and a sectional view of a side surface of the angular velocity sensor 500. The conventional angular velocity sensor 500 comprises a planar substrate 341, a vibrating weight 342 and a housing 343.

The angular velocity sensor 500 has a vibrating weight 342 in the middle of the square planar substrate 341. The housing 343 is formed on the periphery of the planar substrate 341 so as to surround the vibrating weight 342. The conventional angular velocity sensor 500 is arranged so that the x-axis direction which is the vibration direction of the vibrating weight 342 is parallel with the direction of sides of the planar substrate 341 as indicated with an arrow (see Patent Literature 1, for example).
[Patent Literature 1] Japanese Patent Application Publication No. 2010-185739

However, because the angular velocity sensor 500 vibrates the vibrating weight 342 in the direction of the sides of the planar substrate 341, stress concentrates on areas 360 of the planar substrate 341 and the housing 343. In recent years, stress that occurs in the areas 360 has increased along with size reduction of the angular velocity sensor 500, and there has been a concern about the strength of the angular velocity sensor 500.

### SUMMARY

Therefore, it is an object of an aspect of the innovations herein to provide an angular velocity sensor, which is capable of overcoming the above drawbacks accompanying the related art. The above and other objects can be achieved by combinations described in the claims. A first aspect of the present invention provides an angular velocity sensor comprising: a housing the outer edge shape of which is a polygon in a planar view; a planar substrate fixed to the housing; a vibrating weight that is surrounded by the housing and is formed to extend in a perpendicular direction in relation to the planar substrate on the planar substrate; and a vibrating unit to vibrate the vibrating weight in a predetermined direction, wherein the vibrating unit vibrates the vibrating weight in a different direction from a direction of a straight line that connects the shortest distance between the outer edge of the housing and the center of gravity of the vibrating weight in a planar view.

The summary clause does not necessarily describe all necessary features of the embodiments of the present invention. The present invention may also be a sub-combination of the features described above.

### BRIEF DESCRIPTION OF THE DRAWINGS

FIG. 1 is a figure illustrating one example of a conventional angular velocity sensor 500.

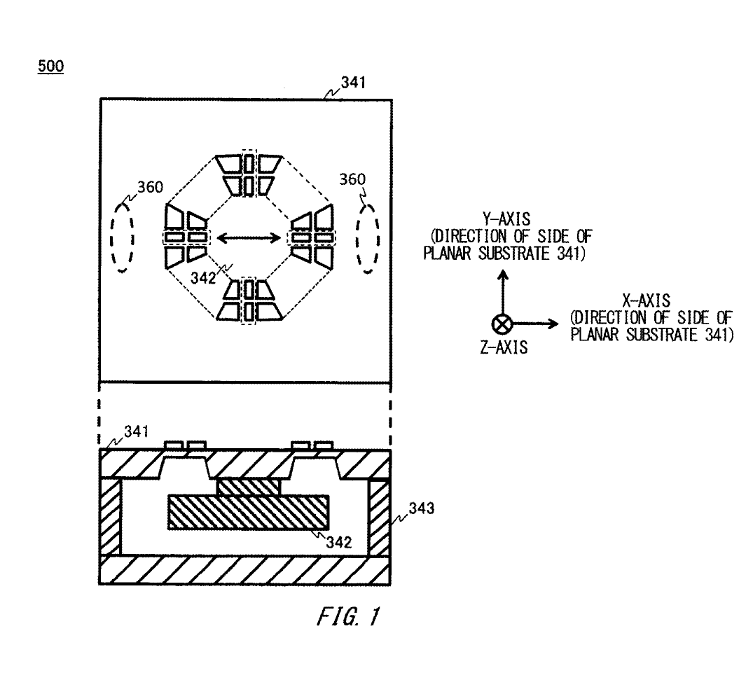

FIG. 2 shows a sectional view of a side surface of an angular velocity sensor 100.

FIG. 3 shows a configuration example of a MEMS 340.

FIG. 4 shows a configuration example of the MEMS 340.

FIG. 5 shows a configuration example of the MEMS 340.

FIG. 6 shows distribution of stress that occurs in the MEMS 340.

FIG. 7 shows distribution of stress that occurs in the MEMS 340.

FIG. 8 shows differences in the deformation amount of the housing 343 corresponding to the vibration direction of the vibrating weight 342.

FIG. 9 shows a sectional view of a top surface of the angular velocity sensor 100.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

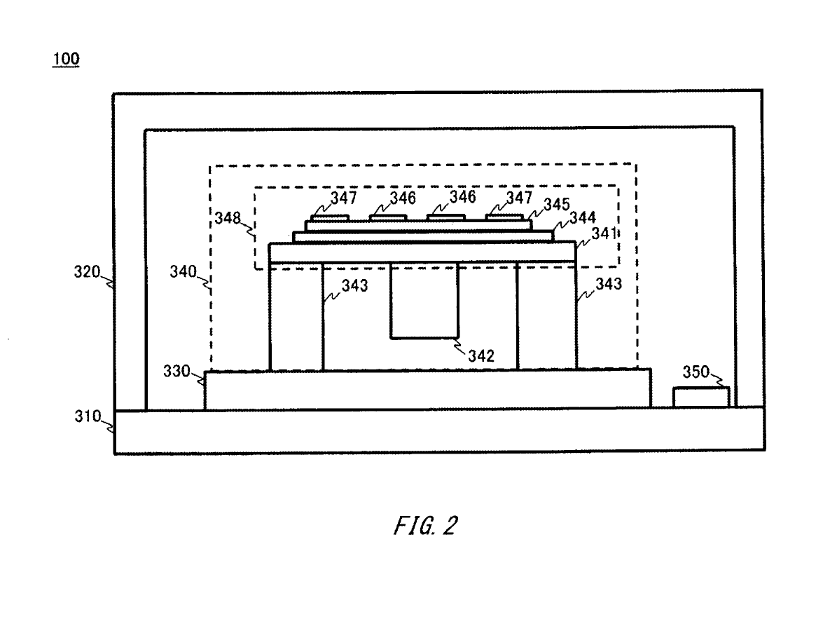

FIG. 2 shows a sectional view of a side surface of an angular velocity sensor 100. The angular velocity sensor 100 comprises a package substrate 310, a case 320, an ASIC 330, a MEMS 340 and an angular velocity calculating unit 350.

The angular velocity sensor 100 detects an angular velocity based on Coriolis force that occurs corresponding to the vibration and angular velocity of the MEMS 340. Coriolis force is inertial force that occurs perpendicularly to the vibration direction of the MEMS 340 when it is vibrated in the angular velocity sensor 100 having angular velocity.

The ASIC 330 and the MEMS 340 are sequentially stacked on the top surface of the package substrate 310. Also, the angular velocity calculating unit 350 is formed on the top surface of the package substrate 310. The case 320 is placed on the package substrate 310 so as to completely cover the ASIC 330, the MEMS 340 and the angular velocity calculating unit 350.

The ASIC 330 outputs a drive signal to vibrate the MEMS 340. The MEMS 340 comprises a vibrating weight 342, a housing 343 and a vibrating unit 348. The vibrating unit 348 comprises a planar substrate 341, a lower electrode 344, a piezoelectric body 345, drive electrodes 346 and detection electrodes 347. The vibrating unit 348 vibrates the vibrating weight 342 in a predetermined direction. The shape of the planar substrate 341 may be a polygon or an elliptical shape.

The vibrating weight 342 of the MEMS 340 vibrates according to the drive signal from the ASIC 330. At this time, Coriolis force corresponding to the angular velocity and the vibration direction of the vibrating weight 342 occurs in the vibrating weight 342. The detection electrodes 347 output a signal corresponding to the Coriolis force that has occurred.

The MEMS 340 is manufactured for example by performing a semiconductor manufacturing process on a SOI substrate having a triple layer structure such as Si—SiO₂—Si. The planar substrate 341 formed with a first Si layer has a fixed periphery, and vibrates according to a drive signal.

The vibrating weight 342 is formed to extend in a perpendicular direction in relation to the planar substrate 341 by performing deep etching on a second Si layer in the SOI substrate. The vibrating weight 342 according to the present example is formed to extend from the middle of the bottom surface of the planar substrate 341 toward the top surface of the ASIC 330. The vibrating weight 342 has a cylindrical, elliptic cylindrical or other shape for example. The vibrating weight 342 vibrates according to a drive signal in a unified manner with the planar substrate 341.

The housing 343 is formed to be unified with the planar substrate 341 on the periphery of the planar substrate 341 by performing deep etching on the second Si layer in the SOI substrate. Also, the housing 343 is formed simultaneously with formation of the vibrating weight 342, and houses the vibrating weight 342. Note that the housing 343 may be formed separately from the planar substrate 341, and fixed on the planar substrate 341 by adhesion or the like.

The housing 343 supports the periphery of the planar substrate 341 when the vibrating weight 342 vibrates. Preferably, the housing 343 is not displaced corresponding to vibration of the vibrating weight 342. Thereby, the vibrating weight 342 can stably vibrate in a predetermined rotational axis direction. When the housing 343 supports the periphery of the planar substrate 341, the shape of the outer edge of the housing 343 and the shape of the planar substrate 341 are the same shape in a planar view. In the present specification, the planar view means that the surface of the planar substrate 341 is seen from directly above. Although in the present example, the housing 343 supports the periphery of the planar substrate 341, an inner side of the planar substrate 341 may be supported. In this case, the shape of the outer edge of the housing 343 may be a polygon, a rectangle or a square in the planar view. Here, a polygon, a rectangle and a square include an approximately polygonal shape, an approximately rectangular shape, and an approximately square shape whose corners are rounded.

The lower electrode 344 and the piezoelectric body 345 are formed by being stacked on the top surface of the planar substrate 341. The lower electrode 344 and the piezoelectric body 345 are formed to cover an area which is in the planar substrate 341 but not fixed to the housing 343. Also, the drive electrodes 346 and the detection electrodes 347 are respectively placed to form pairs at positions that are on the top surface of the piezoelectric body 345 and are symmetric to the vibrating weight 342.

Voltage is applied to the lower electrode 344 such that the voltage becomes constant. For example, the lower electrode 344 is grounded. Also, voltage corresponding to a direction in which the vibrating weight 342 is vibrated is applied to the drive electrodes 346. Thereby, the piezoelectric body 345 is bent corresponding to the difference between the voltage of a drive signal input to the drive electrodes 346 and the voltage of the lower electrode 344.

The drive electrodes 346 are placed in the vicinity of a position corresponding to the periphery of the vibrating weight 342. Because the distance from the inner circumference of the housing 343 which is the fixed end of vibration becomes the longest on the periphery of the vibrating weight 342, a large moment occurs in the piezoelectric body 345 near the periphery of the vibrating weight 342. Accordingly, the drive electrodes 346 can vibrate the vibrating weight 342 more efficiently as compared with a case in which they are provided in the proximity of the housing 343.

The detection electrodes 347 are placed in the vicinity of positions corresponding to the inner circumference of the housing 343. Because the closer the piezoelectric body 345 is to the housing 343, the larger the stress applied at a time of vibration, large current occurs in the piezoelectric body 345 near the inner circumference of the housing 343. Accordingly, the detection electrodes 347 can detect a larger signal when it is provided at a position close to the housing 343 as compared with a case in which it is provided at a position close to the vibrating weight 342.

A signal detected by the detection electrodes 347 is a signal based on Coriolis force that occurs corresponding to the vibration direction of the vibrating weight 342 and the angular velocity of the MEMS 340. The detection electrodes 347 output the detected signal to the angular velocity calculating unit 350.

The angular velocity calculating unit 350 calculates the angular velocity of the angular velocity sensor 100 by processing the signal detected by the detection electrodes 347. The angular velocity calculating unit 350 detects Coriolis force occurring in a perpendicular direction to the vibration direction of the MEMS 340 to measure the angular velocity.

The angular velocity sensor 100 can detect angular velocity along a plurality of rotational axes by switching the vibration direction of the vibrating weight 342. The angular velocity sensor 100 switches the plurality of vibration directions by vibrating the vibrating weight 342 intermittently. Thereby, the angular velocity sensor 100 measures the angular velocity along each rotational axis at any time.

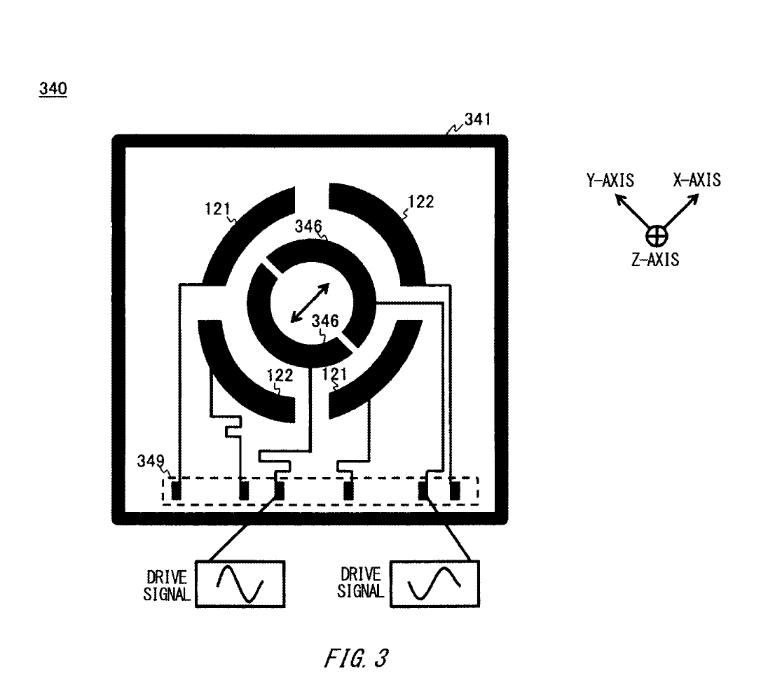

FIG. 3 shows a configuration example of the MEMS 340. The MEMS 340 comprises the rectangular planar substrate 341, the drive electrodes 346, the detection electrodes 347 and an electrode pad 349. FIG. 3 shows the top surface of the MEMS 340, and a plane of the planar substrate 341 is shown as an xy plane. In the present specification, the x-axis corresponds to the vibration direction on a plane parallel with the planar substrate 341, and the y-axis corresponds to a perpendicular direction to the vibration direction on the plane parallel with the planar substrate 341. Also, the z-axis corresponds to a vibration direction in a perpendicular direction in relation to the planar substrate 341.

The MEMS 340 vibrates the vibrating weight 342 so as to form an angle larger than 0 degree but smaller than 90 degrees relative to the straight line that connects the shortest distance between a side of the planar substrate 341 and the vibrating weight 342 on a plane parallel with the planar substrate 341. The vibrating weight 342 according to the present example is vibrated in the x-axis direction that is at 45 degrees relative to the straight line that connects the shortest distance between a side of the planar substrate 341 and the vibrating weight 342. Here, when the shape of the planar substrate 341 is an elliptical shape, the side of the planar substrate 341 corresponds to a curved portion of the ellipse.

In the present specification, placement in which the x-axis and the y-axis are inclined by 45 degrees relative to the straight line that connects the shortest distance between a side of the planar substrate 341 and the vibrating weight 342 is referred to as a 45-degree placement. In the present specification, the term “shortest straight line” refers to the straight line that connects the shortest distance between a side of the planar substrate 341 and the vibrating weight 342. Note that the angle of inclination is not limited to 45 degrees.

The MEMS 340 detects the angular velocity in the z-axis direction and the y-axis direction when the vibrating weight 342 is vibrated in the x-axis direction. In the present specification, the angular velocity in the z-axis direction refers to the angular velocity of rotation around the z-axis as its center. The angular velocity in the x-axis direction and the y-axis direction is defined in a similar manner.

The electrode pad 349 is connected to the drive electrodes 346 and the detection electrodes 347. The electrode pad 349 inputs a drive signal into the drive electrodes 346 to vibrate the vibrating weight 342. The MEMS 340 according to the present example inputs drive signals that are in mutually opposite phases to the drive electrodes 346 respectively in order to vibrate the vibrating weight 342 in the x-axis direction.

The drive electrodes 346 vibrate the vibrating weight 342 corresponding to the input drive signals. The drive electrodes 346 are placed as a pair to form an angle larger than 0 degree but smaller than 90 degrees relative to the shortest straight line on a plane parallel with the planar substrate 341.

The drive electrodes 346 are arrayed on and along the x-axis and provided as a pair so as to be symmetric to the vibrating weight 342. Therefore, when drive signals that are in mutually opposite phases are input to the pair of drive electrodes 346, the vibrating weight 342 is vibrated in the x-axis direction.

The detection electrodes 347 detect a signal that occurs corresponding to vibration of the vibrating weight 342 and output it to the electrode pad 349. The detection electrodes 347 have first detection units 121 and second detection units 122. The first detection units 121 and the second detection units 122 detect Coriolis force in the three axial directions that occurs due to the angular velocity around the z-axis and the y-axis.

The first detection units 121 are arrayed on and along the y-axis and provided as a pair so as to be symmetric to the vibrating weight 342. The first detection units 121 detect force occurring in the perpendicular direction in relation to the vibration direction. Specifically, the first detection units 121 detect Coriolis force in the y-axis direction and Coriolis force in the z-axis direction.

The second detection units 122 are arrayed on and along the x-axis and provided as a pair so as to be symmetric to the vibrating weight 342. The second detection units 122 detect force occurring in the vibration direction. The second detection units 122 detect Coriolis force in the x-axis direction and Coriolis force in the z-axis direction.

The detection electrodes 347 output, to the electrode pad 349, a detected signal obtained by conversion based on Coriolis force detected by the first detection units 121 and the second detection units 122. The electrode pad 349 outputs the detected signal to the angular velocity calculating unit 350. The angular velocity calculating unit 350 calculates the angular velocity of the angular velocity sensor 100 based on an output of the first detection units 121 and the second detection units 122.

The detection electrodes 347 according to the present example have an elliptical shape with their major axis being the x-axis and their minor axis being the y-axis. The distance between a side of the planar substrate 341 and the vibrating weight 342 in the x-axis direction is longer than the distance between the planar substrate 341 and the vibrating weight 342 in the y-axis direction. Thus, the resonant frequency of vibration in the x-axis direction becomes smaller than the resonant frequency of vibration in the y-axis direction. Therefore, vibration of the vibrating weight 342 in the x-axis direction can be prevented from deviating from the x-axis and leaking toward the y-axis direction. Note that a similar effect can be obtained even if the shapes of the planar substrate 341, the vibrating weight 342 and the drive electrodes 346 are elliptical shapes.

In the angular velocity sensor 100, the vibrating unit 348 vibrates the vibrating weight 342 in a different direction from a direction of a straight line that connects the shortest distance between the outer edge of the housing 343 and the center of gravity of the vibrating weight 342 in a planar view. Here, the center of gravity of the vibrating weight 342 refers to the position of the center of gravity of the vibrating weight 342 when the vibrating weight 342 is in a stationary state in which it is not vibrated. Because in the angular velocity sensor 100, the shape of the outer edge of the housing 343 is a polygon, the vibrating unit 348 vibrates the vibrating weight 342 in a different direction from a perpendicular line direction that originates from the center of gravity of the vibrating weight 342 down to a side of the outer edge of the housing 343 in a planar view.

Also, the vibrating unit 348 may vibrate the vibrating weight 342 so that the vibrating weight 342 heads to a corner of the outer edge of the housing 343 from the center of gravity of the vibrating weight 342 in a planar view. Because in this configuration, it becomes hard for vibration of the vibrating weight 342 to be transmitted by the housing 343, the strength of the housing 343 against vibration of the vibrating weight 342 can be made higher.

In the angular velocity sensor 100, a pair of upper electrodes are placed on the straight line that is different from the straight line connecting the shortest distance between the outer edge of the housing 343 and the center of gravity of the vibrating weight 342, and passes through the center of gravity of the vibrating weight 342, in a planar view. In this configuration, the vibrating weight 342 can be vibrated in the above-mentioned different direction. For example, the pair of upper electrodes are the drive electrodes 346.

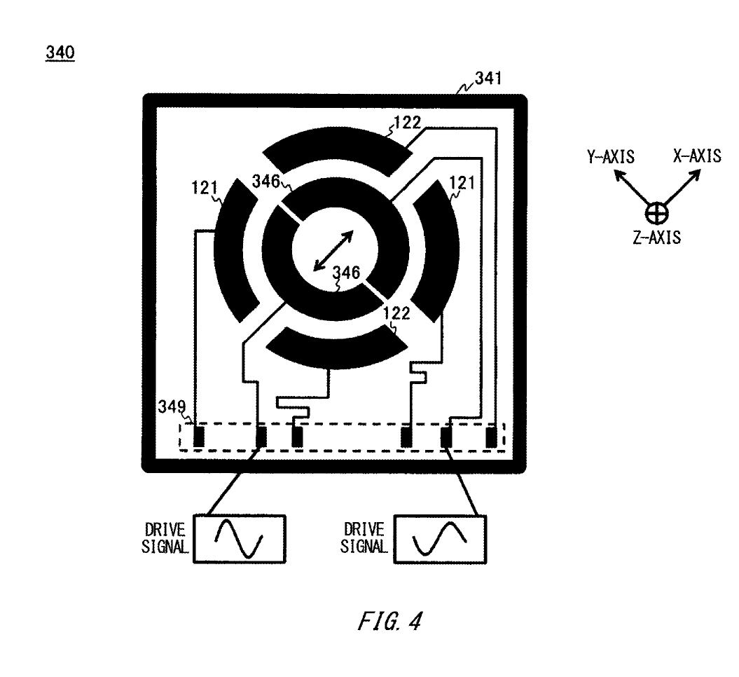

FIG. 4 shows another configuration example of the MEMS 340. As shown in FIG. 4, the vibrating unit 348 may include two pairs of upper electrodes. Each of the two pairs of upper electrodes may be placed so as to sandwich the straight line that is different from the straight line connecting the shortest distance between the outer edge of the housing 343 and the center of gravity of the vibrating weight 342, and passes through the center of gravity of the vibrating weight 342, in a planar view. For example, the two pairs of upper electrodes are the first detection units 121 and the second detection units 122.

As in the present example, when the shape of the outer edge of the housing 343 is a rectangle, the angular velocity sensor 100 vibrates the vibrating weight 342 so as to form an angle larger than 0 degree but smaller than 90 degrees relative to the straight line that connects the shortest distance between the outer edge of the housing 343 and the center of gravity of the vibrating weight 342 in a planar view. For this reason, stress that occurs in the housing 343 in the vibration direction is reduced. Therefore, the angular velocity sensor 100 according to the present embodiment has high strength against vibration of the vibrating weight 342.

When the shape of the outer edge of the housing 343 is a square, and the center of gravity of the vibrating weight 342 and the center of gravity of the outer edge of the housing 343 match, the vibrating unit 348 may vibrate the vibrating weight 342 so as to form an angle of 45 degrees relative to the straight line that connects the shortest distance between the outer edge of the housing 343 and the center of gravity of the vibrating weight 342 in a planar view. In this case, the distance between the outer edge of the housing 343 and the center of gravity of the vibrating weight 342 in a planar view becomes the longest. Thereby, it becomes hard for vibration of the vibrating weight 342 to be transmitted by the housing 343, and the strength of the vibrating weight 342 against vibration becomes even higher. Note that when the shape of the outer edge of the housing 343 is a regular octagon, the vibrating unit 348 only has to vibrate the vibrating weight 342 so as to form an angle larger than 0 degree but smaller than 45 degrees relative to the straight line that connects the shortest distance between the outer edge of the housing 343 and the center of gravity of the vibrating weight 342 in a planar view.

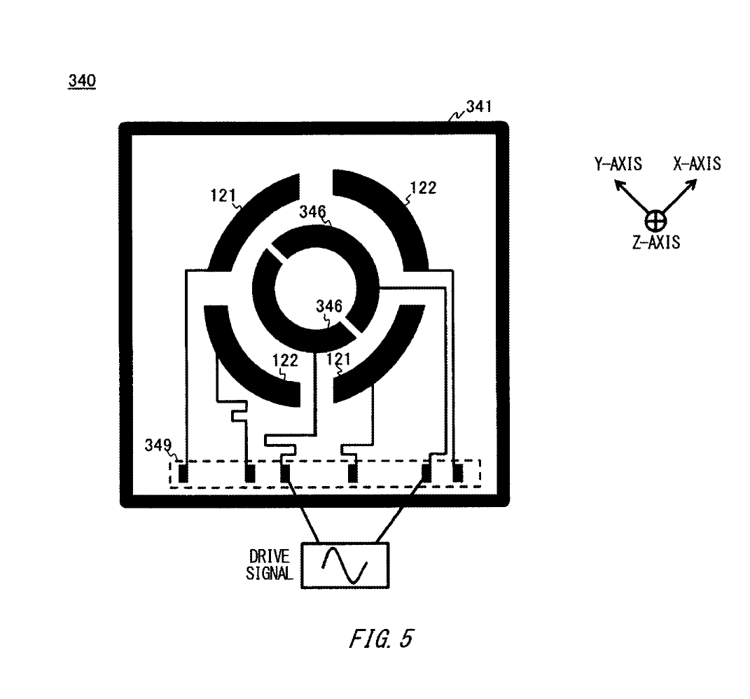

FIG. 5 shows a configuration example of the MEMS 340. FIG. 5 is different from FIGS. 3 and 4 in that the MEMS 340 vibrates the vibrating weight 342 in the z-axis direction. The z-axis is a perpendicular direction in relation to the planar substrate 341.

The electrode pad 349 outputs a drive signal to the drive electrodes 346 to vibrate the vibrating weight 342. The electrode pad 349 according to the present example inputs drive signals in the same phase to the pair of drive electrodes 346.

The drive electrodes 346 are arrayed on and along the x-axis and provided as a pair so as to be symmetric to the vibrating weight 342. When the same drive signals are input to the pair of drive electrodes 346, the vibrating weight 342 is vibrated in the z-axis direction perpendicular to the planar substrate 341.

The detection electrodes 347 output, to the electrode pad 349, a detected signal obtained by conversion based on Coriolis force detected by the first detection units 121 and the second detection units 122. Here, the detected signal is a signal obtained by converting Coriolis force that occurs due to the angular velocity in the x-axis and y-axis directions.

The angular velocity sensor 100 vibrates the vibrating weight 342 in the x-axis direction and detects the angular velocity in the y-axis and z-axis directions. Also, the angular velocity sensor 100 vibrates the vibrating weight 342 in the z-axis direction and detects the angular velocity in the x-axis and y-axis directions.

The angular velocity sensor 100 can switch the vibration of the vibrating weight 342 to the x-axis direction and the z-axis direction and measure the angular velocity in the three axial directions. Therefore, the angular velocity sensor 100 does not have to vibrate the vibrating weight 342 in the y-axis direction for the purpose of measuring the angular velocity in the three axial directions.

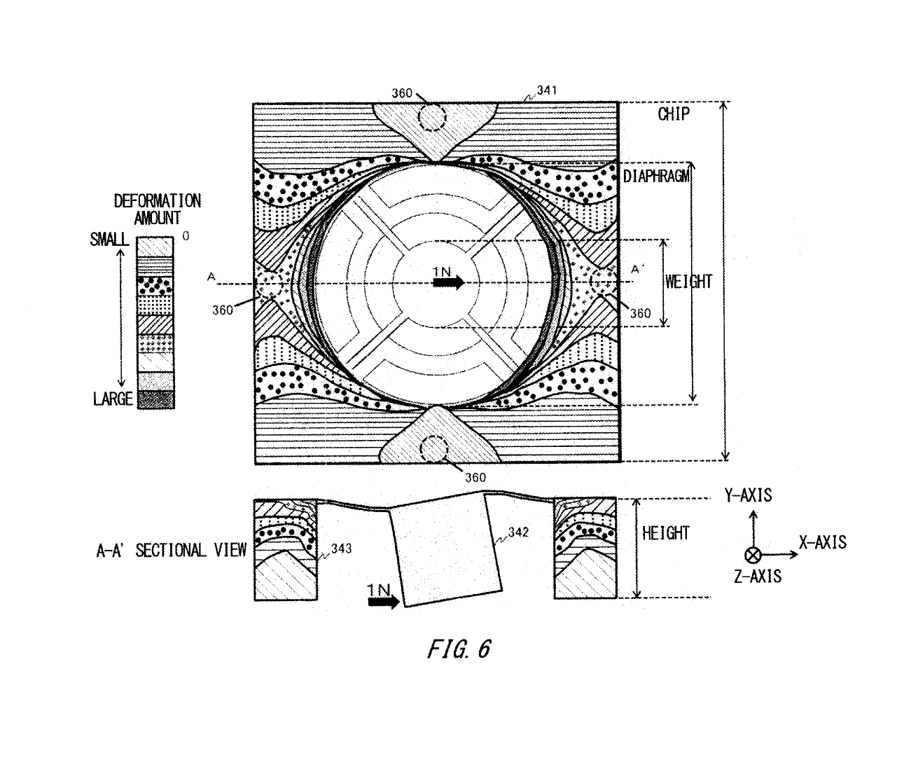

FIG. 6 shows distribution of stress that occurs in the MEMS 340. The top figure in FIG. 6 is a top view of the MEMS 340 and shows the stress distribution in the top surface of the housing 343. The bottom figure in FIG. 6 is an A-A′ sectional view of the MEMS 340 and shows the stress distribution of a section of the housing 343. The stress distribution shows distribution of the deformation amount when energy of 1 N is applied to the vibrating weight 342. Note that patterns in the figure respectively show the deformation amounts of the housing 343. The patterns in the figure divide the magnitude of the deformation amounts at constant intervals. That is, the larger the number of changes in patterns in an area, the larger the deformation amount of the housing 343.

The MEMS 340 has the planar substrate 341 whose directions of sides of the square correspond to the x-axis and the y-axis, respectively. The chip size corresponds to the size of the periphery of the planar substrate 341. The diaphragm size corresponds to the diameter of the inner circumference of the housing 343. The weight size corresponds to the size of the periphery of the vibrating weight 342. Note that the height of the vibrating weight 342 and the housing 343 according to the present example are equal.

Because the vibrating weight 342 is vibrated in the x-axis direction, stress concentrates in the area 360 on the x-axis, and the deformation amount becomes the largest there. On the other hand, almost no stress occurs in the area 360 on the y-axis. That is, in the housing 343, energy applied to the vibrating weight 342 is not dispersed sufficiently on the xy plane, and stress concentrates in the x-axis direction.

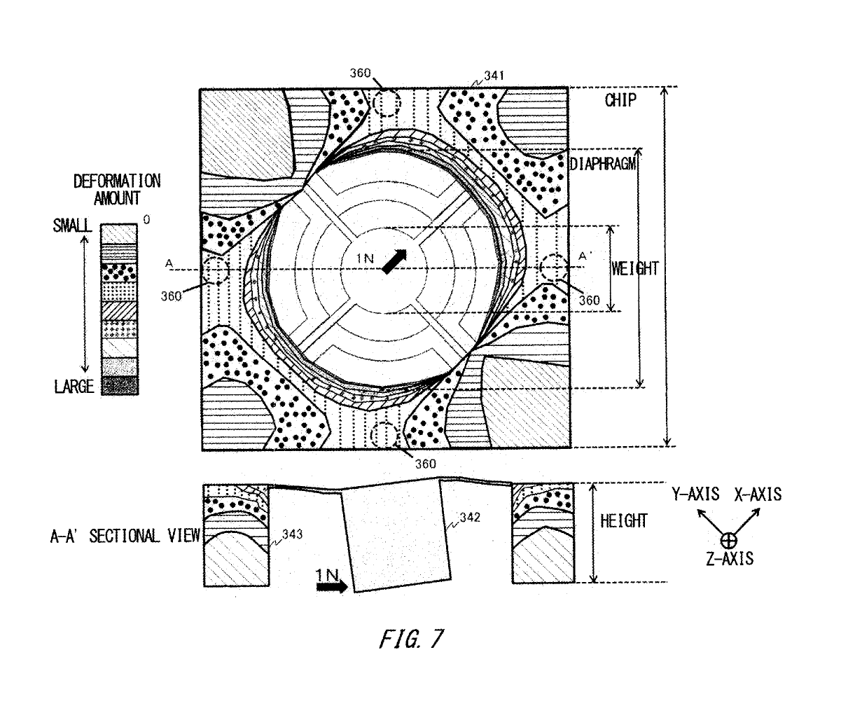

FIG. 7 is a figure illustrating distribution of stress that occurs in the MEMS 340. FIG. 7 is different from FIG. 6 in that the x-axis and the y-axis are inclined by 45 degrees relative to a side of the planar substrate 341.

Because the area 360 is not in the vibration direction of the vibrating weight 342, stress that occurs in the housing 343 is reduced. Also, in the housing 343, because the vibrating weight 342 is vibrated while being inclined by 45 degrees relative to a side of the planar substrate 341, uniform deformation amounts occur in the areas 360 on the x-axis and the y-axis. That is, in the housing 343, stress occurs while energy applied to the vibrating weight 342 is dispersed on the xy plane.

Comparing the sectional views of a side surface of the housing 343 between FIG. 6 and FIG. 7, the sectional view in FIG. 6 shows a larger deformation amount near the surface of the housing 343. Also, notable concentration of stress that occurs in the housing 343 is observed near the inner circumference of the housing 343.

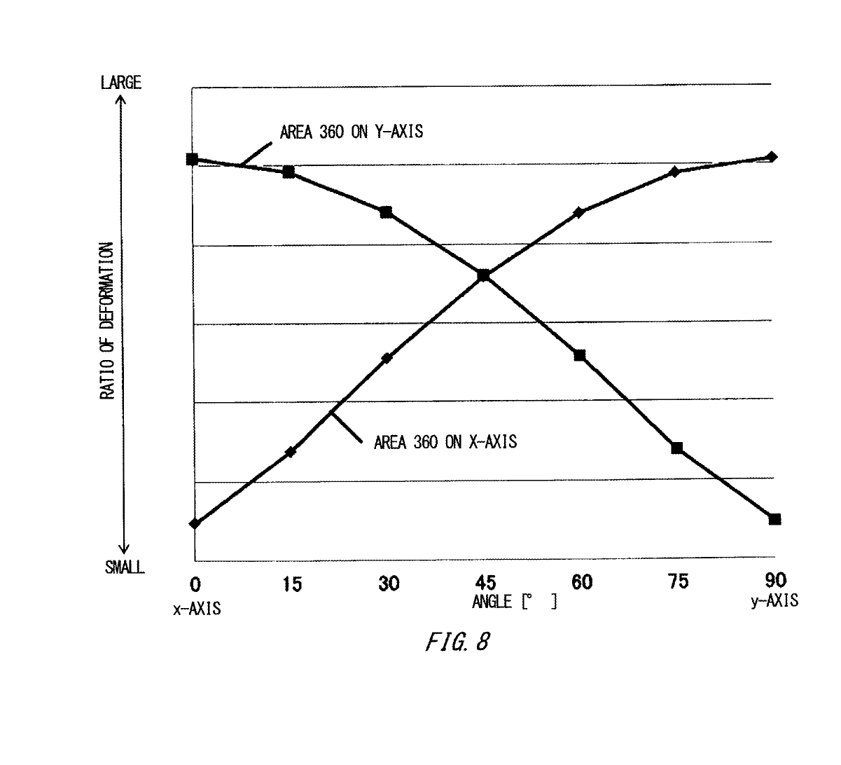

FIG. 8 shows differences in the deformation amount of the housing 343 corresponding to the vibration direction of the vibrating weight 342. The horizontal axis indicates the angle [°] of the vibration direction of the vibrating weight 342 relative to the straight line. The vertical axis indicates the respective deformation amounts occurring in the housing 343 in the areas 360 on the x-axis and on the y-axis. The vibration direction of the vibrating weight 342 is changed by 15 degrees. A diamond-shaped plot is data of the area 360 on the x-axis, and a square plot indicates data of the area 360 on the y-axis.

The deformation amount of the housing 343 in the area 360 on the x-axis becomes the smallest at a time of 0-degree placement. As the angle of the vibration direction increases, the deformation amount increases. On the other hand, the deformation amount of the housing 343 in the area 360 on the y-axis becomes the largest at a time of 0-degree placement. As the angle of the vibration direction increases, the deformation amount decreases.

In the present example, because the shape of the planar substrate 341 is a square, the deformation amounts along the x-axis and the y-axis become symmetric within the plane. Therefore, in a case of the 45-degree placement, the deformation amounts in the areas 360 on the x-axis and on the y-axis become equal. That is, in a case of the 45-degree placement, because stress is dispersed uniformly on the xy plane, the strength of the angular velocity sensor 100 becomes the highest.

The vibrating weight 342 may be vibrated so as to form an angle of 15 degrees or larger but 75 degrees or smaller relative to the shortest straight line or 30 degrees or larger but 60 degrees or smaller relative to the shortest straight line. The vibration direction of the vibrating weight 342 is determined corresponding to the shape of the planar substrate 341 and/or the position at which the vibrating weight 342 is installed. The vibration direction of the vibrating weight 342 may be determined so that stress that occurs due to vibration of the vibrating weight 342 does not concentrate in the area 360.

In the present embodiment, the planar substrate 341 is explained as being a square. However, the shape of the planar substrate 341 is not limited to a square, but may be any shape such as a polygon, an elliptical shape or other shapes. In this case, the vibrating weight 342 is vibrated so as to form an angle larger than 0 degree but smaller than 90 degrees relative to the straight line which is the shortest distance between a side of the planar substrate 341 and the vibrating weight 342. Also, the vibrating weight 342 may be vibrated in a direction of a corner of the planar substrate 341.

The deformation amount of the 45-degree placement is smaller than the deformation amount of the 0-degree placement. Also, as the chip size decreases, the difference between the deformation amount of the 45-degree placement and the deformation amount of the 0-degree placement increases. The deformation amount of the 45-degree placement becomes smaller than the deformation amount of the 0-degree placement. The 45-degree placement provides a more significant effect of restraining the deformation amount of the housing 343 when the chip size decreases.

The ratio between the maximum deformation amount of the housing 343 in a case of the 0-degree placement and the maximum deformation amount of the housing 343 in a case of the 45-degree placement becomes a constant ratio of 1.41 with any chip size. That is, the 45-degree placement provides a certain effect regardless of a chip size, not excluding a case in which the chip size is large.

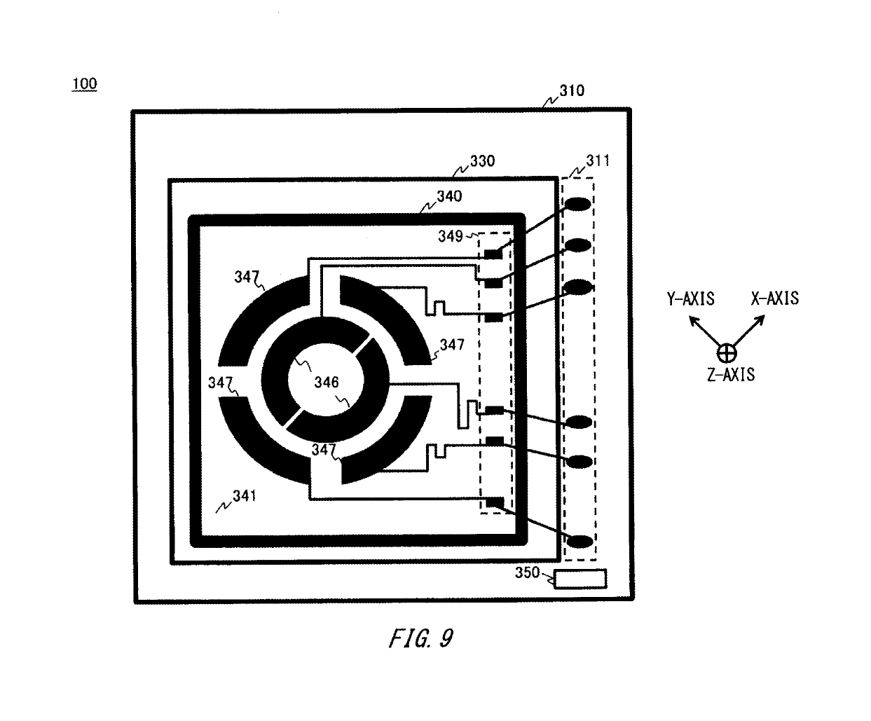

FIG. 9 shows a sectional view of a top surface of the angular velocity sensor 100. The angular velocity sensor 100 comprises the package substrate 310, the ASIC 330, the MEMS 340, the drive electrodes 346, the detection electrodes 347 and the electrode pad 349. A terminal 311 and the angular velocity calculating unit 350 are provided on the package substrate 310. Note that the angular velocity calculating unit 350 may be provided outside the angular velocity sensor 100. Also, the angular velocity calculating unit 350 may be provided inside the ASIC 330.

The electrode pad 349 is connected to each electrode of the drive electrodes 346 and the detection electrodes 347. The electrode pad 349 outputs a drive signal to the drive electrodes 346 and receives a detected signal from the detection electrodes 347. The electrode pad 349 inputs the detected signal to the terminal 311 via wiring.

The terminal 311 outputs the input detected signal to the angular velocity calculating unit 350 via the package substrate 310. The number of the terminals 311 provided corresponds to the numbers of the drive electrodes 346 and detection electrodes 347 used.

The angular velocity calculating unit 350 detects the angular velocity of the angular velocity sensor 100 based on the detected signal. Because the angular velocity calculating unit 350 detects Coriolis force in the axial directions of the xyz coordinate system corresponding to the vibration direction, the angular velocity calculating unit 350 calculates the angular velocity around the axes of the xyz coordinate system.

However, the angular velocity calculated by the angular velocity calculating unit 350 is not limited to the angular velocity around the axes of the xyz coordinate system. The angular velocity calculating unit 350 calculates the angular velocity of a coordinate system different from the xyz coordinate system by performing axial conversion of data of the input detected signal.

For example, assuming that in the axial conversion of the xy plane coordinate, the coordinate before the axial conversion is x, y, the coordinate after the axial conversion is x′, y′, and the rotation angle is a (the counter-clockwise direction is the positive direction), the relationships before and after the axial conversion are expressed by the following equations.

[Equation 1]

x′=x cos α−y sin α

y′=x sin α+y cos α (1)

Here, if the rotation angle α is 45 degrees, Equations (1) is expressed as Equation (2).

$$\begin{matrix}[ Equation 2 ] & \\ {x}^{′} = \frac{1}{\sqrt{2}} ( x - y ) \\ {y}^{′} = \frac{1}{\sqrt{2}} ( x + y ) & ( 2 )\end{matrix}$$

Equation (2) means that the Coriolis force detected becomes 1/√2-fold after the axial conversion, relative to the angular velocity of the same rotational axis. Assuming that outputs of upper and lower detection electrodes of the detection electrode 122 in FIG. 3 are x2 and x1, respectively, and outputs of upper and lower detection electrodes of the detection electrode 121 are y1 and y2, respectively, an output ωx around the x-axis before the axial conversion is:

$$\begin{matrix}\begin{matrix}{ω}_{x} = ( x 2 + y 1 ) - ( x 1 + y 2 ) \\ = ( x 2 - x 1 ) - ( y 2 - y 1 )\end{matrix} & \\ wherein ( x 2 - x 1 ) is 0 & \end{matrix}$$

and

an output ωy around the Y-axis before the axial conversion is:

$$\begin{matrix}\begin{matrix}{ω}_{y} = ( x 2 + y 2 ) - ( x 1 + y 1 ) \\ = ( x 2 - x 1 ) + ( y 2 - y 1 )\end{matrix} & \\ wherein ( y 2 - y 1 ) is 0 & \end{matrix}$$

Also, an output ωx′ around the x′-axis after the axial conversion is:

$$\begin{matrix}{ω}_{x}^{′} = \frac{1}{\sqrt{2}} \{ ( x 2 + y 1 ) - ( x 1 + y 2 ) \} \\ = \frac{1}{\sqrt{2}} \{ ( x 2 - x 1 ) - ( y 2 - y 1 ) \}\end{matrix}$$

and
an output ωy′ around the y′-axis after the axial conversion is:

$$\begin{matrix}{ω}_{y}^{′} = \frac{1}{\sqrt{2}} \{ ( x 2 + y 2 ) - ( x 1 + y 1 ) \} \\ = \frac{1}{\sqrt{2}} \{ ( x 2 - x 1 ) - ( y 2 - y 1 ) \}\end{matrix}$$

That is, an output before the axial conversion is to be obtained by multiplying a difference between outputs of respective detection electrodes by √2. Although the above-mentioned example concerns the 45-degree placement, Equation (1) can be applied to cases where the rotation angle is not 45 degrees.

The angular velocity calculating unit 350 may calculate the angular velocity around a rotational axis when the rotational axis is the direction of a side of the planar substrate 341. That is, the angular velocity calculating unit 350 may calculate the pitch angular velocity. Also, the angular velocity calculating unit 350 may calculate the angular velocity around a rotational axis when the rotational axis is the direction of a side of the package substrate 310. That is, the angular velocity calculating unit 350 may calculate the roll angular velocity. Similarly, the angular velocity calculating unit 350 may calculate the yaw angular velocity. As the angular velocity sensor 100 comprises the angular velocity calculating unit 350 that calculates the pitch and/or roll angular velocity, its housing space within electronic equipment or the like can be small.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As is apparent from the explanation above, an angular velocity sensor to detect Coriolis force by vibrating a vibrating weight can be realized by an embodiment of the present invention.

What is claimed is:

1. An angular velocity sensor comprising:
a housing an outer edge shape of which is a polygon in a planar view;
a planar substrate fixed to the housing;
a vibrating weight that is surrounded by the housing and is formed to extend in a perpendicular direction in relation to the planar substrate on the planar substrate; and
a vibrating unit to vibrate the vibrating weight in a predetermined direction, wherein
the vibrating unit vibrates the vibrating weight in a different direction from a direction of a straight line that connects the shortest distance between the outer edge of the housing and the center of gravity of the vibrating weight in a planar view, and
a resonant frequency of the vibrating weight vibrating in the different direction is different from a resonant frequency of the vibrating weight vibrating in a direction orthogonal to the different direction.

2. The angular velocity sensor according to claim 1, wherein a shape of the housing that supports an inner side of the planar substrate is an ellipse.

3. The angular velocity sensor according to claim 1, wherein the different direction of the vibrating weight is parallel with a diagonal line of the planar substrate.

4. The angular velocity sensor according to claim 1, wherein the vibrating unit vibrates the vibrating weight in a different direction from a perpendicular line direction that originates from the center of gravity of the vibrating weight down to a side of the outer edge of the housing in a planar view.

5. The angular velocity sensor according to claim 4, wherein the vibrating unit vibrates the vibrating weight so that the vibrating weight heads toward a corner of the outer edge of the housing from the center of gravity of the vibrating weight in a planar view.

6. The angular velocity sensor according to claim 1, wherein the vibrating unit has:
a lower electrode provided on the planar substrate;
a piezoelectric element provided on the lower electrode; and
at least one pair of upper electrodes that are provided on the piezoelectric element and placed at positions that are symmetric to the vibrating weight.

7. The angular velocity sensor according to claim 6, wherein the at least one pair of upper electrodes are placed on a straight line that is different from the straight line connecting the shortest distance between the outer edge of the housing and the center of gravity of the vibrating weight, and passes through the center of gravity of the vibrating weight, in a planar view.

8. The angular velocity sensor according to claim 6, wherein
the vibrating unit has two pairs of the upper electrodes, and
each of the two pairs of upper electrodes are placed so as to sandwich a straight line that is different from the straight line connecting the shortest distance between the outer edge of the housing and the center of gravity of the vibrating weight, and passes through the center of gravity of the vibrating weight, in a planar view.

9. The angular velocity sensor according to claim 1, wherein the shape of the outer edge the housing is a rectangle.

10. The angular velocity sensor according to claim 9, wherein the shape of the outer edge of the housing is a square.

11. The angular velocity sensor according to claim 10, wherein the center of gravity of the vibrating weight and the center of gravity of the outer edge of the housing match in a planar view.

12. The angular velocity sensor according to claim 11, wherein the vibrating unit vibrates the vibrating weight so as to form an angle larger than 0 degree but smaller than 90 degrees relative to a perpendicular line that originates from the center of gravity of the vibrating weight down to the outer edge of the housing.

13. The angular velocity sensor according to claim 12, wherein the vibrating unit vibrates the vibrating weight so as to form an angle of 45 degrees relative to the perpendicular line.

14. The angular velocity sensor according to claim 1, wherein the housing is formed to be unified with the planar substrate.

15. The angular velocity sensor according to claim 1, wherein the vibrating weight is formed to contact the planar substrate or to be unified with the planar substrate.

16. The angular velocity sensor according to claim 1, comprising a first detection unit to detect force occurring in a perpendicular direction in relation to the predetermined direction.

17. The angular velocity sensor according to claim 16, comprising a second detection unit to detect force occurring in the predetermined direction.

18. The angular velocity sensor according to claim 1, wherein
the housing supports a periphery of the planar substrate, and
the planar substrate has a shape that is the same as the shape of the outer edge of the housing in a planar view.

19. The angular velocity sensor according to claim 17, comprising an angular velocity calculating unit to calculate an angular velocity of the angular velocity sensor based on an output of the first detection unit and the second detection unit.

20. The angular velocity sensor according to claim 19, wherein the angular velocity calculating unit calculates an angular velocity around a rotational axis when the rotational axis is the direction of a side of the planar substrate.

21. The angular velocity sensor according to claim 19, wherein the angular velocity calculating unit calculates a pitch and/or roll angular velocity.

22. The angular velocity sensor according to claim 19, wherein the angular velocity calculating unit calculates an angular velocity around a rotational axis when the rotational axis is the direction of a side of a packaging member that packages the planar substrate and the vibrating weight.

23. The angular velocity sensor according to claim 17, wherein an output of the first detection unit and the second detection unit is output to an angular velocity calculating unit that calculates an angular velocity of the angular velocity sensor.
